(19) United States
(12) Patent Application Publication
(10) Pub. No.: US 2007/0248043 A1
(43) Pub. Date: Oct. 25, 2007

(54) Method, computer-readable medium, and apparatus for dynamic resource allocation across FDD and TDD systems

(75) Inventors: Alireza Afrashteh, Great Falls, VA (US); Masoud Olfat, Calrksville, MD (US); Douglas A. Hyslop, Fairfax, VA (US); Rajesh M. Gangadhar, Ashburn, VA (US)

Correspondence Address: SPRINT NEXTEL CORPORATION, 6391 SPRINT PARKWAY, MAILSTOP: KSOPHT0101-Z2100, OVERLAND PARK, KS, 66251-2100, US

(73) Assignee: NEXTEL COMMUNICATIONS, INC., Reston, VA (US)

(21) Appl. No.: 11/407,035

(22) Filed: Apr. 20, 2006

(51) Int. Cl. H04Q 7/00

(52) U.S. Cl. 370/329; 370/227

(57) ABSTRACT

A method, computer-readable medium, and apparatus for dynamically assigning radio resources between a frequency division duplexing (FDD) carrier and a time division duplexing (TDD) carrier is provided. The method includes monitoring radio frequency conditions and traffic load of the FDD and TDD carriers; allocating a resource assignment for a downlink on the FDD carrier or the TDD carrier, based upon the radio frequency conditions or the traffic load of the FDD and TDD carriers; and allocating a resource assignment for an uplink on the FDD carrier or the TDD carrier, based upon the radio frequency conditions or the traffic load of the FDD and TDD carriers.

### BACKGROUND OF THE INVENTION

Wireless frequency spectrum is controlled by government bodies. These government bodies allocate the frequency spectrum to particular wireless operators, and place conditions on how the frequency spectrum is used. For example, allocated frequency spectrum is typically required to operate either in a time division duplex (TDD) or frequency division duplex (FDD) mode. In a system that operates in a TDD mode, the uplink and downlink channels share the same frequency band, but are transmitted and received by the base station during mutually exclusive periods of time. In a system that operates in an FDD mode, the uplink and downlink channels are transmitted simultaneously on different frequency bands.

The 2.5 GHz frequency spectrum currently consists of TDD spectrum, and is being partially re-banded to support FDD. Currently, Code Division Multiple Access (CDMA) and the IEEE 802.16 standard, which uses Orthogonal Frequency Division Multiple Access (OFDMA), both support TDD and FDD modes. Typically, systems which use CDMA or the IEEE 802.16 standard operate in either a TDD or FDD mode.

Next-generation systems that will be deployed in the 2.5 GHz band for wireless broadband services must be flexible in spectrum utilization to maintain a low-cost base and support deployment under geographically varying spectrum positions. Ownership of the 2.5 GHz spectrum is fragmented, with many licensees owning small channels with a certain geographic limit. In order to minimize deployment cost and the cost of capacity growth, the next-generation technology deployed in this band must be flexible enough to support TDD, where a TDD spectrum is owned, to support FDD, where an FDD spectrum is owned, and to support a capacity growth plan that minimizes the cost of utilizing new pieces of spectrum that become available. However, current systems are designed in such a way that a base station supports only TDD or FDD operation.

### SUMMARY OF THE INVENTION

The present invention provides a method, apparatus, and computer-readable medium for dynamically assigning radio resources between a frequency division duplexing (FDD) carrier and a time division duplexing (TDD) carrier. Simultaneous use of both TDD and FDD schemes can help significantly enhance the achieved capacity of the resources.

With FDD and TDD operating simultaneously with the same technology, the allocation of resources between the two modes becomes an issue. Exemplary embodiments of the present invention employ a single receive and transmit chain to reduce device cost and complexity. Such a device can only operate in either the TDD or the FDD mode at any instant. However, frequency selective fading, traffic load within the sector, and interference from surrounding sectors vary as a function of time, frequency, and device location. Therefore, to optimize the capacity of the two systems, exemplary embodiments of the present invention provide a smart resource allocation scheme that can dynamically assign resources on the two duplexing schemes is required.

This is a new problem introduced by the capability of certain air interface technologies to support both TDD and FDD modes of operation. This allows the technology to operate in spectrum that supports both types of duplexing schemes. Traditionally, spectrum allocations are clearly defined to be either TDD or FDD. As described above, the 2.5 GHz band is deviating from this approach, prompting new innovations to ensure the lowest-cost deployment approach.

Other objects, advantages and novel features of the present invention will become apparent from the following detailed description of the invention when considered in conjunction with the accompanying drawings.

### BRIEF DESCRIPTION OF THE DRAWINGS

FIG. 1 illustrates an exemplary allocation of resources between an FDD carrier and a TDD carrier;

FIG. 2 illustrates a flow diagram of an exemplary method according to the present invention;

FIG. 3 illustrates an exemplary embodiment of a base station in accordance with the present invention;

FIG. 4 illustrates an exemplary method for allocating uplink resources in accordance with the present invention; and

FIG. 5 illustrates an exemplary method for allocating downlink resources in accordance with the present invention.

### DETAILED DESCRIPTION OF THE EXEMPLARY EMBODIMENTS

In accordance with the present invention, devices are able to interoperate between TDD and FDD modes of operation and are able to receive or transmit in either mode. The interoperability can occur on a burst-by-burst basis, where a burst is a single unit of resource allocation. Exemplary embodiments of the present invention include a dynamic resource allocation scheme that will be able to assign radio resources dynamically to a device across the two duplexing schemes.

For a downlink resource assignment, a base station constantly monitors conditions of both TDD and FDD carriers, which can be provided by downlink measurements from devices operating on both carriers. For example, the radio frequency (RF) conditions and traffic load on the TDD and FDD carriers can be monitored. The RF conditions may include interference and channel fading, for example, and the traffic load can be an instantaneous load. The base station dynamically assigns radio resources to a user on either the TDD or FDD carrier, depending upon the monitored conditions. Similarly, for uplink resource assignment to individual devices, the base station can utilize measurements at its receiver on both carriers, and can assign resources to the device on the carrier with the best RF conditions and lightest traffic load, for example. In effect, the resource assignment with this scheme includes not only radio resources (such as CDMA codes or OFDMA sub-channels), but also RF carrier resources (TDD versus FDD). Resource assignments are signaled to the devices via the control channels or other messaging protocols/processes. The efficiency of switching between TDD and FDD operation will depend on the device processing power, the physical layer (PHY) and media access control (MAC) layer design of the air interface technology.

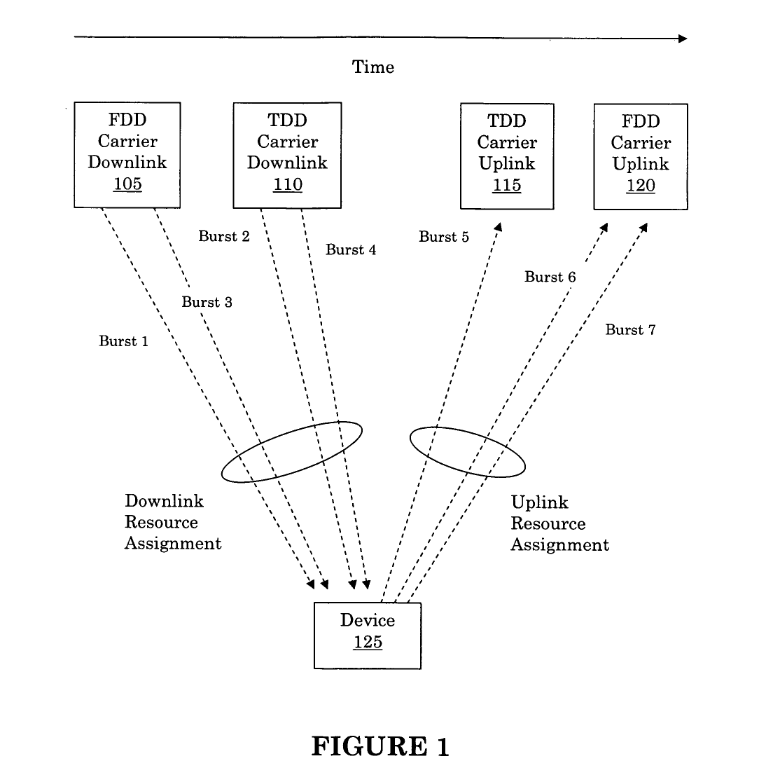

FIG. 1 illustrates an exemplary allocation of resources between an FDD carrier and a TDD carrier. As illustrated in FIG. 1, a device 125 can be allocated resources initially on the FDD carrier 105 and receive Burst 1 on that carrier. The device 125 may be a mobile station, for example. Subsequently, the device 125 can be signaled to receive Burst 2 assignment from the TDD carrier 110, followed by Burst 3 on FDD carrier 105 and Burst 4 on the TDD carrier 110. When the device is ready to transmit, it can be allocated resources on the TDD carrier 115 initially (Burst 5), followed by subsequent allocations on the FDD carrier 120 (Bursts 6 and 7).

A significant advantage of this scheme is that the device can receive or transmit on the most optimal carrier, from an RF and traffic perspective, while minimizing the device transceiver complexity, by requiring a single RF transmit/receive chain.

The present invention encompasses the expanded case of multiple FDD and TDD carriers in a sector or site. Thus, although only one FDD carrier and one TDD carrier are illustrated in FIG. 1, a plurality of FDD and TDD carriers may be used.

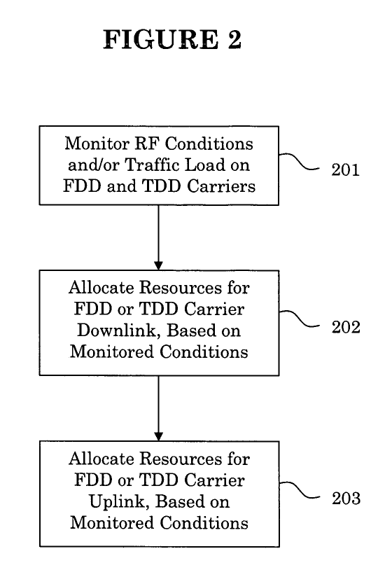

FIG. 2 illustrates a flow diagram of an exemplary method according to the present invention. In the method illustrated in FIG. 2, a base station monitors the RF conditions and/or the traffic load on the FDD carrier and the TDD carrier (step 201). The radio frequency conditions may be provided by downlink measurements from devices operating on the FDD and TDD carriers. The base station allocates resources for the FDD carrier or the TDD carrier downlink, based upon the RF conditions and/or the traffic load on the FDD carrier and the TDD carrier (step 202). The resources can be allocated on a burst-by-burst basis, for example. Also, the base station allocates resources for the FDD carrier or the TDD carrier uplink, based upon the RF conditions and/or the traffic load on the FDD carrier and the TDD carrier (step 203). The resource assignments may be allocated to a carrier having best radio frequency conditions and/or lightest traffic load.

In another exemplary embodiment of the present invention, a computer-readable medium encoded with a computer program for dynamically assigning radio resources between a frequency division duplexing (FDD) carrier and a time division duplexing (TDD) carrier is provided. The term “computer-readable medium” as used herein refers to any medium that participates in providing instructions for execution. Such a medium may take many forms, including but not limited to, non-volatile media, volatile media, and transmission media. Non-volatile media includes, for example, optical or magnetic disks. Volatile media includes, for example, dynamic memory. Transmission media includes coaxial cables, copper wire and fiber optics. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave, or any other medium from which a computer can read.

An exemplary embodiment of a computer-readable medium encoded with a computer program for dynamically assigning radio resources between a frequency division duplexing (FDD) carrier and a time division duplexing (TDD) carrier is illustrated in FIG. 2, which is described above.

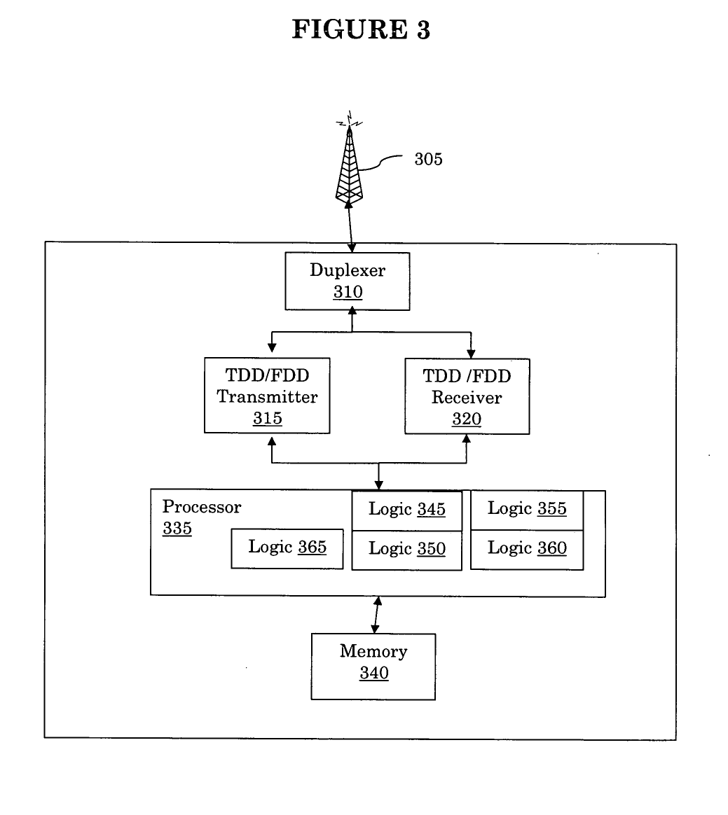

FIG. 3 is a block diagram illustrating an exemplary base station in accordance with the present invention. The base station includes a base station antenna 305 coupled to a duplexer 310. The duplexer 310 is coupled to a TDD/FDD transmitter 315 and a TDD/FDD receiver 320. The transmitter 315 and receiver 320 represent the entire radio frequency processing chain, i.e., they can include down converters, baseband processors, and the like. Although FIG. 3 illustrates only one TDD/FDD transmitter 315 and one TDD/FDD receiver 320, the base station can have more than one of each, if the base station supports more than one TDD channel and more than one FDD channel pair.

Processor 335 is coupled to transmitter 315 and receiver 320, and includes logic 345, 350, 355, 360, and 365. Logic 345 can allocate a resource assignment for a downlink on an FDD carrier, logic 350 can allocate a resource assignment for an uplink on the FDD carrier, logic 355 can allocate a resource assignment for a downlink on a TDD carrier, and logic 360 can allocate a resource assignment for an uplink on the TDD carrier. Logic 365 can monitor RF conditions and traffic load of the TDD and FDD carriers. Processor 335 can be a microprocessor, field programmable gate array (FPGA), application specific integrated circuit (ASIC) and/or the like. Processor 335 is coupled to a memory 340. Memory 340 can be a random access memory (RAM), read only memory (ROM), flash memory, hard disk and/or the like. The operation of an exemplary base station is described above in connection with FIGS. 1 and 2.

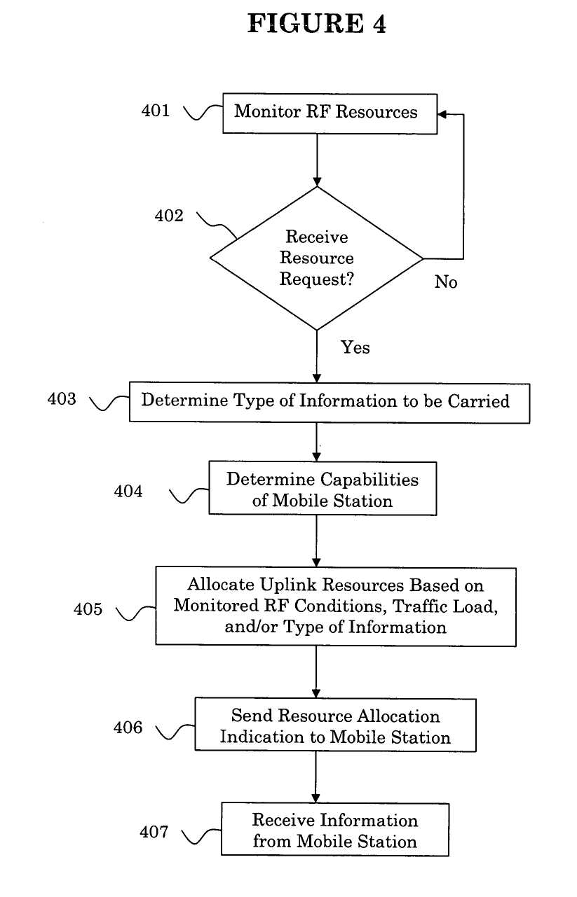

FIG. 4 illustrates an exemplary method for allocating uplink resources in accordance with the present invention. In the method of FIG. 4, the RF resources are monitored (step 401). If a resource request is received in step 402, the type of information to be carried by a carrier is determined (step 403). The types of information may include voice data and video data, for example. If no resource request is received in step 402, the method returns to step 401 and monitors the RF resources. In an exemplary embodiment, the RF resources may include the frequency conditions and the traffic load on FDD and TDD carriers. In step 404, the capabilities of a mobile station are determined. For example, it may be determined whether the mobile station can operate in TDD mode, FDD mode, or both TDD and FDD modes. If the mobile station can only operate in TDD mode, for example, only TDD mode will be used for an uplink. Uplink resources are allocated based on monitored RF conditions, traffic load, and/or the type of information to be carried (step 405). In step 406, a resource allocation indication is sent to the mobile station, and, in step 407, information is received from the mobile station.

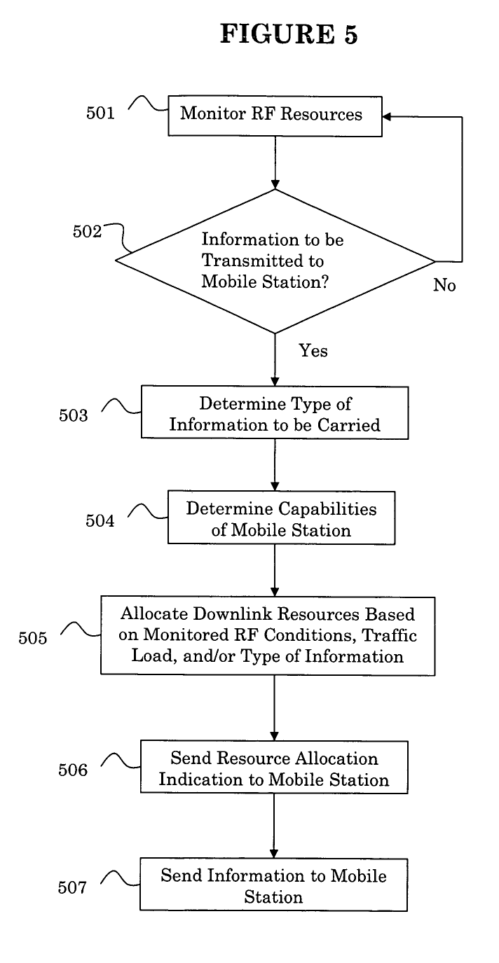

FIG. 5 illustrates an exemplary method for allocating downlink resources in accordance with the present invention. The method illustrated in FIG. 5 includes the following: monitoring RF resources (step 501), determining whether information is to be transmitted to a mobile station (step 502), determining the type of information to be carried by the TDD and FDD carriers, determining the capabilities of the mobile station (step 504), allocating downlink resources based on monitored RF conditions, traffic load, and/or the type of information to be transmitted (step 505), sending a resource allocation indication to the mobile station (step 506), and sending the information to the mobile station (step 507). If it is determined in step 502 that information is not to be transmitted to the mobile station, the method returns to step 501 and monitors the RF resources.

The methods described above in connection with FIGS. 4 and 5 can be performed by a base station and/or any other resource allocation entity.

While the invention has been described in connection with various embodiments, it will be understood that the invention is capable of further modifications. This application is intended to cover any variations, uses or adaptation of the invention following, in general, the principles of the invention, and including such departures from the present disclosure as, within the known and customary practice within the art to which the invention pertains.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for dynamically assigning radio resources between a frequency division duplexing (FDD) carrier and a time division duplexing (TDD) carrier, the method comprising the acts of:
monitoring radio resources of the FDD and TDD carriers;
allocating a resource assignment for a downlink on the FDD carrier or the TDD carrier, based upon the radio resources of the FDD and TDD carriers; and
allocating a resource assignment for an uplink on the FDD carrier or the TDD carrier, based upon the radio resources of the FDD and TDD carriers.

2. The method of claim 1, wherein the radio resources are provided by downlink measurements from devices operating on the FDD and TDD carriers.

3. The method of claim 1, wherein the resource assignments are allocated on a burst-by-burst basis.

4. The method of claim 1, wherein the radio resources comprise at least one of radio frequency conditions and traffic load.

5. The method of claim 4, wherein the resource assignments are allocated to a carrier having best radio frequency conditions or lightest traffic load.

6. A method for dynamically assigning radio resources between a plurality of frequency division duplexing (FDD) carriers and a plurality of time division duplexing (TDD) carriers, the method comprising the acts of:
monitoring radio resources of each of the FDD and TDD carriers;
allocating resource assignments for downlinks on the FDD carriers or the TDD carriers, based upon the radio resources on each of the FDD and TDD carriers;
allocating resource assignments for uplinks on the FDD carriers or the TDD carriers, based upon the radio resources of each of the FDD and TDD carriers.

7. The method of claim 6, wherein the radio resources are provided by downlink measurements from devices operating on the FDD and TDD carriers.

8. The method of claim 6, wherein the resource assignments are allocated on a burst-by-burst basis.

9. The method of claim 6, wherein the radio resources comprise at least one of radio frequency conditions and traffic load.

10. The method of claim 9, wherein the resource assignments are allocated to a carrier having best radio frequency conditions or lightest traffic load.

11. A computer-readable medium encoded with a computer program for dynamically assigning radio resources between a frequency division duplexing (FDD) carrier and a time division duplexing (TDD) carrier, the computer program comprising instructions for:
monitoring radio resources of the FDD and TDD carriers;
allocating a resource assignment for a downlink on the FDD carrier or the TDD carrier, based upon the resources of the FDD and TDD carriers; and
allocating a resource assignment for an uplink on the FDD carrier or the TDD carrier, based upon the radio resources of the FDD and TDD carriers.

12. The computer-readable medium of claim 11, wherein the radio resources are provided by downlink measurements from devices operating on the FDD and TDD carriers.

13. The computer-readable medium of claim 11, wherein the resource assignments are allocated on a burst-by-burst basis.

14. The computer-readable medium of claim 11, wherein the radio resources comprise at least one of radio frequency conditions and traffic load.

15. The computer-readable medium of claim 14, wherein the resource assignments are allocated to a carrier having best radio frequency conditions or lightest traffic load.

16. A base station for dynamically assigning radio resources between frequency division duplexing (FDD) and time division duplexing (TDD) carriers, comprising:
a processor including:
logic for monitoring radio resources of the FDD and TDD carriers;
logic for allocating a resource assignment for a downlink on the FDD carrier or the TDD carrier, based upon the radio resources of the FDD and TDD carriers; and
logic for allocating a resource assignment for an uplink on the FDD carrier or the TDD carrier, based upon the radio resources of the FDD and TDD carriers.

17. The base station of claim 16, wherein the radio resources comprise at least one of radio frequency conditions and traffic load.

18. The base station of claim 17, wherein the resource assignments are allocated to a carrier having best radio frequency conditions or lightest traffic load.

19. A method for allocating radio resources by a base station supporting channels of at least two different types of channel duplexing, the method comprising the acts of:
monitoring radio resources of the channels of the at least two different types of channel duplexing;
allocating a resource assignment for a downlink on one of the channels, based upon the monitored radio resources of the channels; and
allocating a resource assignment for an uplink on one of the channels, based upon the monitored radio resources of the channels.

20. The method of claim 19, wherein the radio resources are provided by downlink measurements from devices operating on the channels.

21. The method of claim 19, wherein the resource assignments are allocated on a burst-by-burst basis.

22. The method of claim 19, wherein the radio resources comprise at least one of radio frequency conditions and traffic load.

23. The method of claim 22, wherein the resource assignments are allocated to a carrier having best radio frequency conditions or lightest traffic load.

24. A method for receiving radio resources by a mobile station supporting channels of at least two different types of channel duplexing, the method comprising the acts of:
receiving a channel allocation for a channel of one of the at least two different types of channel duplexing; and
communicating with a base station using the allocated channel.

25. A method for dynamically assigning radio resources between a frequency division duplexing (FDD) carrier and a time division duplexing (TDD) carrier for an uplink, the method comprising the acts of:
monitoring radio resources of the FDD and TDD carriers;
determining a type of information to be received via the uplink; and
allocating a resource assignment for the uplink on the FDD carrier or the TDD carrier, based upon the radio resources of the FDD and TDD carriers and the type of information to be received.

26. The method of claim 25, wherein the type of information to be received comprises at least one of voice data and video data.

27. The method of claim 25, further comprising the acts of:
determining whether a mobile station is capable of operating in an FDD mode; and
determining whether the mobile station is capable of operating in a TDD mode;
wherein the allocating of the resource assignment is further based upon which of the FDD and TDD modes the mobile station is capable of operating in.

28. A method for dynamically assigning radio resources between a frequency division duplexing (FDD) carrier and a time division duplexing (TDD) carrier for a downlink, the method comprising the acts of:
monitoring radio resources of the FDD and TDD carriers;
determining a type of information to be transmitted via the downlink; and
allocating a resource assignment for the downlink on the FDD carrier or the TDD carrier, based upon the radio resources of the FDD and TDD carriers and the type of information to be transmitted.

29. The method of claim 28, wherein the type of information to be received comprises at least one of voice data and video data.

30. The method of claim 28, further comprising the acts of:
determining whether a mobile station is capable of operating in an FDD mode; and
determining whether the mobile station is capable of operating in a TDD mode;
wherein the allocating of the resource assignment is further based upon which of the FDD and TDD modes the mobile station is capable of operating in.
